(19) United States
(12) Patent Application Publication
(10) Pub. No.: US 2026/0226953 A1
(43) Pub. Date: Aug. 6, 2026

(54) A METHOD FOR MATERIAL LOSS DETECTION, IN PARTICULAR FOR WEAR DETECTION, AN ARRANGEMENT FOR PERFORMING THIS METHOD

(71) Applicant: RVmagnetics, a.s., Košice (SK)

(72) Inventor: Rastislav Varga, Hodkovce (SK)

(21) Appl. No.: 19/148,975

(22) PCT Filed: Jan. 23, 2024
(86) PCT No.: PCT/IB2024/050612

§ 371 Date: Jul. 17, 2025

(30) Foreign Application Priority Data
Jan. 26, 2023 (SK) PP 50006-2023

(51) Int. Cl. F16D 66/02; G01N 3/56; G01N 27/72

(52) U.S. Cl. CPC F16D 66/028; G01N 3/56; G01N 27/72

(57) ABSTRACT

At least one, preferably at least two bistable magnetic elements (1), which are adapted for magnetization reversal in the dynamic magnetic field of the reading device (2), are positioned in the material wear zone. The material loss is accompanied by a decrease in the number of detected bistable magnetic elements (1). The presence of the bistable magnetic element (1) is detected by the reading device (2) based on the evaluation of the magnetization reversal response of the bistable magnetic element (1), when typical, narrow local maxima (e) are searched for in the received signal. Advantageously, a magnetic field with triangular shape is used, which has essentially a linear increase in excitation, which conveniently separates the maxima of several bistable magnetic elements (1). The reading device (2) can be a permanent part of the system or it can be a portable device that is used during a service or inspection of the particular device. The small size of the bistable magnetic element (1) and the quick method of evaluation enable a wide range of applications, especially in means of transport, in handling and lifting technology and the like.

### TECHNICAL FIELD

The invention relates to a method for material loss detection, in particular of solid material during the process of gradual wear, in which detection elements positioned in the material layer are used. The subject of the invention is also an arrangement for performing a new method for material loss detection, wherein the system can be used for movable and non-movable elements, especially in machine elements, in parts and components in transport and lifting technology, in the mining industry, in the energy industry and the like. For the US territory, this application is a continuing application of the parent application EP22166892.4, which discloses the general principles of measuring various physical quantities using a bistable magnetic wire.

### BACKGROUND ART

To determine the rate of wear and assess the service life of various components, parts and tools, optometric methods or methods are used that use the interruption of an electric circuit that is passed through a layer of material in the zone of its wear or also use a method that determines the presence of a detection element or several detection elements in the wear zone.

Publication DE198070004 A1 describes a sensor in a tire that contactless communicates with a reading unit to which it sends wear data. The disadvantage of this arrangement is the complexity of the wear evaluation and also the sending of data to the module in the vehicle body.

The system according to the document DE102009010983 A1 uses at least one electric or magnetic element which is placed in a certain layer of the component material. The electric or magnetic response of an electric or magnetic element is detected with the help of a detector. When the part wears up to the layer with the placed electric or magnetic element, there is a loss of electric or magnetic response and this condition is evaluated as wear to the level of the respective layer. This publication describes the general principle of wear detection, which is also described in other older documents. However, in the practical implementation of this general principle, the detection of the electric or magnetic response is significantly complicated by the surrounding electric and magnetic fields and random phenomena. The solution to these problems is not clarified in the file.

Publication AU2014200336 A1 describes RFID chips placed in several layers of material in the wear zone of the conveyor belt, preferably also in several places in the profile of the conveyor belt. This document provides a partial solution to the previously mentioned problems, where the presence of RFID chips with a specific identification is detected by means of an RFID reader, which makes it possible to detect the condition of the RFID chip falling out or breaking in the corresponding position when the layer of the conveyor belt is cut. The disadvantage is the relatively large size of the RFID chip, which defines the recognizable thickness of wear in individual steps and also the relative complexity of reading REID codes, especially at higher speeds of the conveyor belt.

A technical solution for wear detection is desired and not known, which will enable wide use in various applications, will use a small detection element and at the same time will be reliable for contactless information transmission even in a field noisy with various electric and magnetic sources.

### SUMMARY OF INVENTION

The aforementioned shortcomings are largely eliminated by a method for material loss detection, in particular wear detection, in which at least one detection element is positioned in a material wear zone and subsequently the material loss is evaluated by detecting the presence or absence of the detection element using a reading device according to the present invention, the nature of which is in that the detection element is a bistable magnetic element which is adapted for magnetization reversal in an excitation magnetic field of the reading device, and when detecting the material loss, the presence of the bistable magnetic element is detected by the reading device through evaluating the response of the magnetization reversal of the bistable magnetic element. Based on this response, the presence of one or more bistable magnetic elements in the wear zone is determined. The absence of the corresponding signal is evaluated as wear of the material into the layer or through the layer in which the corresponding bistable magnetic element was positioned. It is not necessary to clearly identify the detection element. All bistable magnetic elements in a given application can be the same, i.e. without unique identification among themselves, it is sufficient to measure their number, since gradual wear layer by layer can always be reliably assumed. An arrangement in which the individual bistable magnetic elements are identified and when their number is detected, the correctness of the gradual loss of the bistable magnetic elements can be checked, is also not excluded.

Bistable magnetic elements are known for the measurement of various physical quantities and positions, where the bistable magnetic element forms a passive member, which by its magnetization reversal reacts to a change in position or to a change in a physical quantity. In this invention, it is not necessary to evaluate a physical quantity as a manifestation of a change in the state of the bistable magnetic element, but it is sufficient to evaluate the presence or absence of the bistable magnetic element. This simplifies and accelerate detection.

An important advantage of the invention is the fact that the bistable magnetic element, e.g. preferably in the form of a bistable magnetic wire, has a small size and it is also relatively cheap. The bistable magnetic wire has usually a diameter of less than 50 μm, preferably less than 25 μm, particularly preferably less than 15 μm and is therefore also referred to as bistable magnetic microwire or bistable magnetic hair. This allows to create several layers of detection with fine dimensional gradation, and at the same time this allows to significantly increase the accuracy of wear measurement, in particular for solid materials, in which wear is risky even when a thin layer of material is lost. The small size of the bistable magnetic element also provides the advantage of a relatively small intervention in the mechanical and strength properties of the respective component. The bistable magnetic element in the form of a wire or a microwire or a strip is resistant to external influences and can be easily inserted into the material without the risk of damage, as it does not need neither a power source, nor any control circuit or code carrier, as is the case, e.g. with RFID elements.

The mutual spacing of the individual detection layers will be chosen according to the required measurement range, e.g. in the case of tires it can be on the order of millimeters, in total even more than 10 mm (for truck casings) and in the case of metal parts the layers can be spaced on the order of tenths or hundredths of a millimeter. Usually, the available depth H of the wear material will be divided equally over the selected number of layers according to the relationship:

$$H = x \cdot d$$

$$or$$

$$H = ( x - 1 ) \cdot d$$

where x is the number of bistable magnetic elements, d is the distance between the layers.
   Depending on the nature of wear of a particular material or the nature of the critical condition of the given device, the distribution of layers with bistable magnetic elements may also be inhomogeneous.

In some embodiments, it can be advantageous if at least some layer, e.g. the last layer or the first layer or even all wear layers, is provided with several bistable magnetic elements. Such embodiment can serve to increase reliability or to increase accuracy of detection, while using small dimensions and low price of bistable magnetic elements, especially in the form of microwires.

The moment of signal loss on the reading device occurs when the bistable magnetic element falls out of the corresponding layer, when this layer is exposed due to wear and the bistable magnetic element does not have mechanical support to remain in its position, or when the structure of the bistable magnetic element is disturbed, when a part of the bistable magnetic element remains in the corresponding layer, but the bistable magnetic element is disturbed (e.g. ground) so much that the receiving signal on the reading device is substantially changed or completely disappeared. This detection mechanism means that the absence of the presence of the bistable magnetic element is to be understood in this document as the absence of the presence of the functional bistable magnetic wire, i.e. capable of causing the expected response in the receiving device. The loss of this functionality may precede the moment of later complete falling out of the bistable magnetic element of the respective layer.

Upon detection in materials in which the bistable magnetic element will be gradually shortened, a gradual reduction of the response amplitude, usually down to the background limit, can also be evaluated.

When measuring the presence of the bistable magnetic element, magnetic excitation with a triangular signal is advantageously used, usually with a symmetrically triangular signal and with an asymmetry of the excitation field, as described in the previous patent application of the same applicant EP22166892.4. This process significantly simplifies the evaluation of the measured response signal, allows measurement at high frequency and solves several shortcomings known from the state of the art, when the evaluation of the response was unstable as a result of complex magnetic manifestations during magnetization reversal in a number of domains within one bistable magnetic element.

The presence of the bistable magnetic element is detected by measuring the induced response, where one bistable magnetic element manifests itself as one peak within one half-period of the excitation magnetic signal. The detected response peak is very well recognizable, the amplitude of the response exceeds at least twice the amplitude of the spurious background, usually the amplitude of the response exceeds at least five times the amplitude of the background noise. Such a sharp peak can be easily diagnosed and is not undesirably affected by interference from the surrounding electromagnetic field, which is always present in common industrial practice and difficult to predict more precisely in advance. As documented in the figures in the examples, the response peaks are easily and clearly identifiable in the received signals. Thanks to that, the evaluation is fast, accurate, insensitive to various secondary influences, and it is possible to diagnose several bistable magnetic elements with discretely separated response peaks on one half-period of the excitation magnetic signal. A narrow peak in the received signal is a manifestation of jump magnetization reversal at a certain amplitude of the excitation magnetic field, which gradually increases linearly and periodically.

When inventing this technical solution, it was found that to detect the response, it is not necessary to analyze the course of the measured response by complex numerical methods, it is sufficient to set the amplitude limit, the exceeding of which in the response within one excitation half-wave identifies the presence of one bistable magnetic element.

Since the measurement can theoretically take place in only one half-period of excitation, the required time during which the reading device reaches the bistable magnetic element or the group of bistable magnetic wires is extremely short, an order of magnitude significantly shorter than, for example, when reading RFID chips from the state of the art. This increases the application possibilities of the present invention in movable, e.g. rotating or sliding or circulating components, such as wheels, rotors, tires, pulleys, bands, belts, ropes, because the excitation signal can have a high frequency that is several times, or even an order of magnitude, higher than the frequency of rotation of the component, or than the frequency of occurrence of the part of the component with the bistable magnetic element positioned within the range of the reading device.

At the same time, it is advantageous if the frequency of the excitation magnetic field is chosen and set so that in the time window when the bistable magnetic element or the group of bistable magnetic elements is within the range of the reading device, several waves of the excitation signal are effectively sent. Outside this time window, no peak from the bistable magnetic element will be recognized on the received response. In principle and without technical problems, relatively high excitation frequencies are applicable, so that within one half-wave of the excitation magnetic signal, one bistable magnetic element will never be received repeatedly, which would otherwise lead to wrong interpretation of the number of bistable magnetic elements in the wear zone.

When choosing the excitation frequency, the frequencies of surrounding devices that could influence the electromagnetic field within the range of the reading device can be taken into account, and the excitation frequency is chosen outside the frequency range of the surrounding devices. For example, in the case of devices powered from the public electricity network, the excitation frequency is set outside 50 Hz and eventually also outside the harmonic multiples of this frequency. In the case of a changing frequency, e.g. in frequency converters for starting and after-running of motors, the entire adjustable spectrum of frequencies can be taken into account. In the case of use, e.g. in a car, such frequencies are chosen that are outside the band which, e.g. is generated by magnetic sensors in the vicinity, e.g. ABS sensors in the wheel storage bearings.

Due to the nature of the disclosed method, for the moving components and the non-moving reading device, it is suitable if, even with the maximum permitted material loss, one, last bistable magnetic element or a group of last bistable magnetic elements remains in the respective layer for the last, critical level of wear. This means that the level of maximum permissible wear is determined when the penultimate bistable magnetic element or penultimate group in the sequence falls off or is disturbed. In such arrangement, the received signal will be absent during the movement of the component until the time window when the last bistable magnetic element is within the range of the reading device. The absence of the received signal will therefore not be interpreted as the maximum allowed wear, but as the condition beyond the diagnostic time window. At the same time, this allows to determine that the complete loss of the signal, i.e. the loss of the signal even in the assumed time window, is the signal transmission or signal processing failure. In another embodiment, the critical level of wear may be signaled by the loss of all bistable magnetic elements. In that case, it will be appropriate to provide information from other data sources (from other sensors) that the zone in which the bistable magnetic elements were positioned is within the range of the reading device.

In an advantageous process, the reading device can be directly or indirectly connected to a respective component movement control or sensor, when information about the movement of the component is obtained, the repetition frequency of the time window is calculated and this can be compared with the frequency of receiving the response. In such a case, it is possible to determine, for example, that despite the repeated movement of the component, no response is received, which will signal another malfunction in the diagnostic process. Alternatively, it is also possible to change the frequency of the excitation magnetic signal according to the information from the respective component movement control or sensor. It can be, e.g. data from a frequency converter of an elevator, data from an ABS sensor, data from a turbine speed sensor and the like, i.e. in principle data from systems with an already existing hardware element without the need to add a new sensor. There is also possible process, in which the frequency of occurrence of the time window with the received response at the beginning of adaptation to the specifically applied system is recognized during diagnostics, and in the next measurement cycle, the frequency of the excitation magnetic field is adjusted up or down according to the set algorithm.

The loss detection may include the step of identifying that the part or the component is in stationary position in such manner that the bistable magnetic element is permanently within range of the reading device. This depends on coincidence or slippage for systems with different breaks in motion. In such case, the excitation of the magnetic field can be interrupted, since the output of the detection is steadily the same data about the number of functional bistable magnetic elements. According to the program, the excitation in the reading device is resumed when the component moves, which is detected based on data from the superior system, or the excitation is repeated at different time intervals.

The method for material loss detection, in particular the method for wear detection, is possible and at the same time advantageous in the mode where the bistable magnetic elements are positioned in advance in the inspected parts or components, e.g. in the elevator rope, and the detection is performed during a service inspection using a portable reading device. In such a process, the investment costs for detection are essentially negligible, since the bistable magnetic elements are very small and cheap, and the portable reading device is used in several places. The operator places the reading device at a designated place, e.g. to the guide of the elevator rope, starts the elevator in such way that the place with the positioned bistable magnetic elements passes by the reading device, and the measurement is immediately evaluated. One pass of the rope is sufficient. In other embodiments, e.g. when measuring tire wear, the permanent presence of the reading device will be advantageous, when the detection will not take place continuously, but at specified intervals during movement or immediately after movement of the tire.

The shortcomings mentioned in the state of the art are substantially eliminated by an arrangement for material loss detection itself, in particular for wear detection, which comprises at least one detection element and a reading device for detecting the presence of the detection element, wherein at least one detection element is positioned in the material loss zone according to this of the invention, the nature of which is that the detection element is a bistable magnetic element that is adapted for magnetization reversal in the excitation magnetic field of the reading device and the detection element is within the range of the reading device at least during the detection time window.

As disclosed in the method of detection, the reading device is adapted for evaluating the presence of at least one bistable magnetic element, preferably at least two or three bistable magnetic elements. When using a group of bistable magnetic elements, these are positioned in layers in the direction of the material loss gradient during wear.

The bistable magnetic wire preferably takes the form of a bistable magnetic wire with a diameter of less than 50 μm and with a length that exceeds its diameter more than a hundred times, preferably more than a thousand times. The elongated bistable magnetic wire is advantageously positioned perpendicularly to the material loss gradient, so that when the material is lost into the respective layer, a shock change occurs, i.e. the bistable magnetic wire is released, or it is disturbed to the state of inability to respond to the excitation magnetic signal. The bistable magnetic element is adapted to magnetization reversal by a single Barkhausen front jump from the first end to the second end or vice versa, where the excitation element and the bistable magnetic wire are arranged in such a mutual position in which the amplitude of the magnetic field excited by the excitation element at the first end is different from the amplitude of the magnetic field excited by the excitation element at the other end.

A typical construction of the bistable magnetic element includes an amorphous metal core and a cover, e.g. a glass cover, whose outer diameter is no larger than three times the diameter of the metal core. The thickness of the glass cover can reach 1 to 20 μm. The glass cover, the glass surface layer, protects the metal core from electrical contact with the surrounding environment, from an aggressive chemical environment, thanks to which the bistable magnetic element can be used very universally. The invention can be used in the mining industry and energy industry, where the bistable magnetic element is insensitive to the external environment and at the same time is inert to the surrounding environment, e.g. to the oil of the lubrication system. The loss of the detection properties of the bistable magnetic wire due to high temperature (exceeding the Curie temperature), e.g. in chip machining tools, indirectly indicates damage of the component.

In one of the advantageous arrangements, the arrangement can be supplemented with a component movement sensor with a positioned bistable magnetic element, or it can be connected to a superior system that controls or detects the movement of the respective component. In another arrangement, the reading device can serve as a speed sensor for a superior control system, when each material loss detection sequence signals one cycle, i.e. one revolution of the wheel or one revolution of the conveyor belt.

The reading device will typically comprise a power element which according to the instructions sends a power supply to the excitation element, regulated to obtain a triangular excitation signal. The evaluation element in the reading device acquires and analyzes the response received from the bistable magnetic element, primarily identifies the number of peaks within one half-wave of the excitation magnetic signal. To the detected number, it assigns the state of loss according to the interpretation rule set in the program, which takes into account the specific depth of the layers with bistable magnetic elements.

To measure the response, the antenna of the excitation element can be used or preferably the system includes a separate receiving element, e.g. in the form of a receiving coil. In such a case, the excitation element can be a primary coil, and the receiving element is formed by a secondary coil. The secondary coil can be connected to an amplifier and an evaluation unit.

A significant advantage of the present invention is the high speed of measurement, the reliability of detection, even in the case of a short time window of a moving component, contactless signal transmission resistant to interference and thus also a wide range of possible applications in various sectors. A simple method of evaluating amplitude peaks based only on exceeding the set value of the signal also reduces the cost of the device.

### BRIEF DESCRIPTION OF DRAWINGS

The invention is explained in more detail through FIGS. 1 to 7. Sizes of response amplitudes and shapes of the excitation element specifically shown are only examples, which should not be interpreted as a narrowing of the required protection of the invention.

FIG. 1 shows a block schematic representation of an arrangement with three bistable magnetic elements in different successive layers of material wear. For clarity, the layer spacings are shown out of scale to the displayed thickness of the bistable magnetic element.

FIG. 2 shows a simplified representation of wear detection on an elevator drive pulley.

FIG. 3 shows the time window recorded while the pulley is rotating. The part labeled as B is without the received response signal, the part labeled as A is the time window that corresponds to receiving the signal.

FIG. 4 shows the signal received from one bistable magnetic element during two successive waves of magnetic excitation. The peak corresponding to the presence of the bistable magnetic element is labeled with the letter e. The dashed line represents an example of setting a value, exceeding of which is evaluated as the presence of the response of the bistable magnetic element in the received signal.

In FIG. 5, the signals received successively from five to one bistable magnetic element during one half-wave of magnetic excitation are shown in sequence. The sequence presents wear up to the last layer.

FIG. 6 shows an example of two excitation coils of the reading device when measuring tire wear.

The signals in FIG. 7 document that even with different magnetic bistable elements, in principle, equally readable and clearly interpretable response is achieved.

### EXAMPLES OF EMBODIMENTS

### Example 1

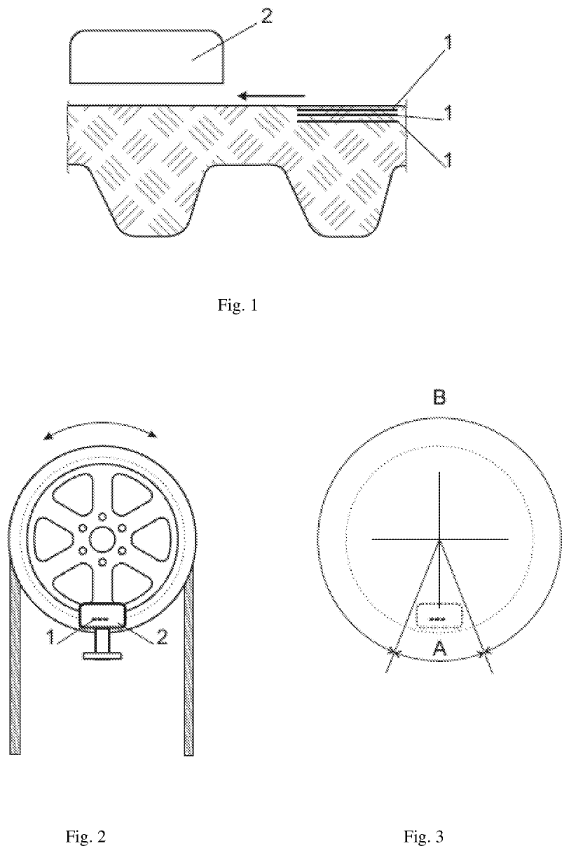

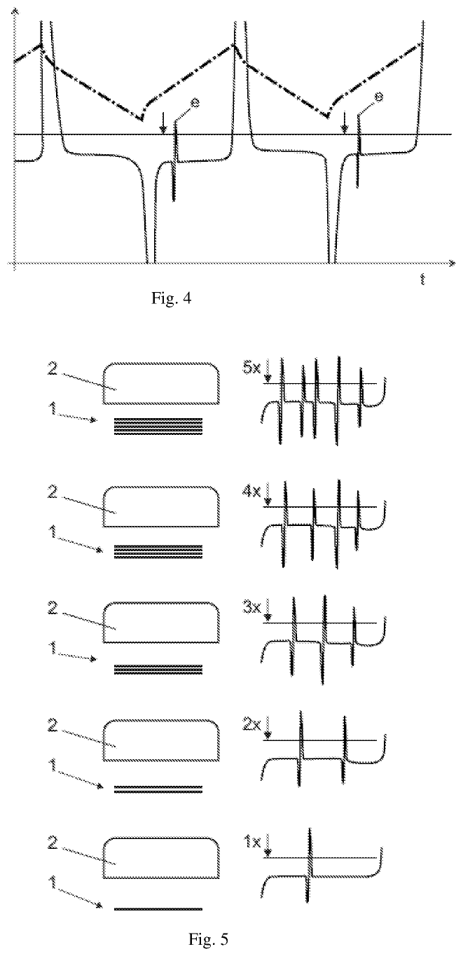

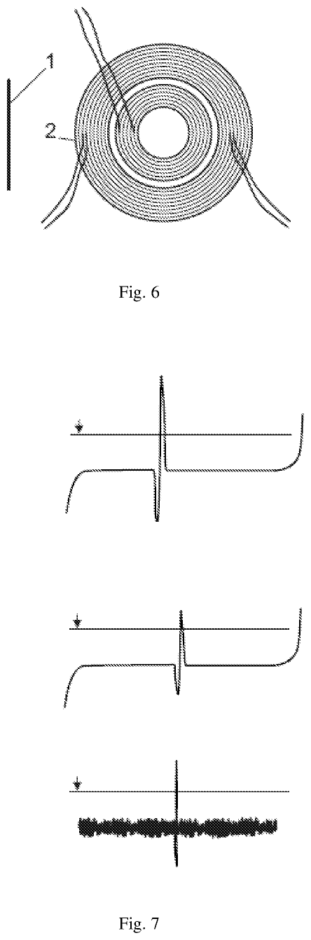

In this example, according to FIGS. 1 to 5, the wear of the drive pulley of the elevator mechanism is detected, where the ropes are both driven and braked by friction. The condition of the pulley also indirectly signals the wear of the ropes. At the perimeter of the pulley, in the zone of contact with the rope, two bistable magnetic elements 1 in the form of microwire are successively glued layer by layer.

In this example, the reading device 2 is permanently attached to the perimeter of the pulley. The pulley rotates during the operation of the elevator and the place with the glued bistable magnetic wires comes cyclically within the range of the reading device 2. The program controls the detection in this example in such manner that once a day the reading device 2 is activated when the elevator moves. The detection of the presence of two bistable magnetic elements 1 represents a normal state when wear has not exceeded a safe level. The detection of one bistable magnetic wire indicates wear below the determined safe level. If no bistable magnetic element 1 is detected during the time window, a fault condition is detected.

In this example, the frequency of the excitation magnetic field is stable, at the level of approx. 1000 Hz, which is absolutely sufficient at relatively low pulley speeds.

### Example 2

A group of bistable magnetic elements 1, which are inserted into the tread of the tire, is used to measure the tire wear of the vehicle. The reading device 1 is placed inside the casing and sends the obtained data to the communication module near the tire. The activation frequency of the reading device 2 is from 10 to 1000 Hz, depending on whether the measurement takes place in motion or in a state of rest. The excitation frequency for the rotating wheel can also be set to avoid the actual frequency of the signals of the ABS sensor or other background with a sufficient distance.

### Example 3

To detect wear of a conveyor belt, groups of bistable magnetic elements 1 are positioned in several places of its profile. Each group is evaluated by a separate reading device 2 in the corresponding width of the conveyor belt. By this the wear is detected in several places within the width of the conveyor belt.

### Example 4

In this example, wear of a turbine main bearing is detected. The advantage of using the bistable magnetic element 1 is the fact that it is functional even in a high temperature environment when lubricated with oil and the remains of the bistable magnetic wire 1 after its grinding do not constitute a threat in the lubrication system.

### Example 5

In a system with a large number of places with wear, the detection of system reliability and service life is set so that the bistable magnetic elements fall into the lubrication system, then they are captured in a filter, where the number of captured bistable magnetic elements is read. When the set number of bistable magnetic elements in the filter is recognized, the state of critical wear is reported without the need to have the reading device in several places of the system.

### INDUSTRIAL APPLICABILITY

The industrial applicability is obvious. According to the present invention, it is possible to industrially and repeatedly detect material loss by detecting the presence of one or more bistable magnetic elements in the material loss zone. The invention is applicable primarily in transport technology, in cable cars and elevators, in the tool evaluation in industrial production, in safety systems of various critical devices and the like.

### REFERENCE SIGNS LIST

1—bistable magnetic element
2—reading device
A—time window with received response
B—time without received response
e—local peak of the response signal

1. A method for material loss detection, in particular for wear detection, in which at least one detection element is positioned in a material wear zone and subsequently the material loss is evaluated by detecting the presence of the detection element using a reading device,
wherein the detection element is a bistable magnetic element which is adapted for magnetization reversal in a dynamically changing excitation magnetic field of the reading device,
and the presence of the bistable magnetic element is detected by the reading device based on evaluating the response of the magnetization reversal of the bistable magnetic element in a received signal.

2. The method for material loss detection, in particular for wear detection, according to claim 1, wherein an amplitude that at least twice exceeds the background level in the received signal is considered to be the response of the bistable magnetic element in the received signal.

3. The method for material loss detection, in particular for wear detection, according to claim 1, wherein the reading device periodically excites the magnetic field with a triangular signal shape.

4. The method for material loss detection, in particular for wear detection, according to claim 3, wherein the excitation frequency is in the range of 1 to 10 000 Hz, especially outside the electromagnetic field frequencies of the surrounding devices.

5. The method for material loss detection, in particular for wear detection, according to claim 1, wherein the excitation frequency is set such that at least five waves of magnetic excitation are emitted within range of the bistable magnetic element during the time window of detection, the results from 60% of the most matching measurements are used for the analysis of the repetitive response during one time window.

6. The method for material loss detection, in particular for wear detection, according to claim 1, wherein the number of measured local peaks (e) of the response signal during one excitation half-wave corresponds to the number of bistable magnetic elements being present.

7. The method for material loss detection, in particular for wear detection, according to claim 6, wherein the local peak (e) is determined by exceeding a set value of the response amplitude in the received signal.

8. The method for material loss detection, in particular for wear detection, according to claim 1, wherein the excitation frequency of the reading device varies according to the speed of movement or the speed of rotation of the component with the bistable magnetic element.

9. The method for material loss detection, in particular for wear detection, according to claim 1, wherein the portable reading device is used, which is temporarily brought closer to the material loss zone during service or inspection.

10. The method for material loss detection, in particular for wear detection, according to claim 1, wherein the permanently positioned reading device is used, which is activated according to a set timing algorithm or according to a set operation interval of the device with the component on which the material loss is detected.

11. An arrangement for material loss detection, in particular for wear detection, comprising at least one detection element and a reading device for detecting the presence of the detection element, wherein the detection element is positioned in the material loss zone, wherein the detection element is a bistable magnetic element that is adapted for magnetization reversal in the excitation magnetic field of the reading device, and the bistable magnetic element is within the range of the reading device during at least one time window.

12. The arrangement for material loss detection, in particular for wear detection, according to claim 11, wherein the bistable magnetic element is a bistable magnetic wire with a diameter of less than 50 μm and with a length that exceeds its diameter more than a hundred times.

13. The arrangement for material loss detection, in particular for wear detection, according to claim 11, wherein the bistable magnetic element has an elongated shape and is positioned substantially perpendicularly to the material loss gradient.

14. The arrangement for material loss detection, in particular for wear detection, according to claim 11, wherein the excitation element of the reading device and the bistable magnetic element are arranged in mutual position, in which the size of the amplitude of the magnetic field excited by the excitation element at the first end of the bistable magnetic element is different from the size of the amplitude of the magnetic field excited by the excitation element at the other end of the bistable magnetic element.

15. The arrangement for material loss detection, in particular for wear detection, according to claim 11, wherein it comprises at least three bistable magnetic elements, which are positioned in different layers sequentially in the material loss direction.

16. The arrangement for material loss detection, in particular for wear detection, according to claim 11, wherein the reading device is positioned on the moving component and is connected by a contactless communication channel to an evaluation and/or display module.
